(19) United States
(12) Patent Application Publication
(10) Pub. No.: US 2016/0300148 A1
(43) Pub. Date: Oct. 13, 2016

(54) ELECTRONIC SYSTEM AND METHOD FOR ESTIMATING AND PREDICTING A FAILURE OF THAT ELECTRONIC SYSTEM

(71) Applicant: ZENTRUM MIKROELEKTRONIK DRESDEN AG, Dresden (DE)

(72) Inventor: Anthony KELLY, Old Kildimo (IE)

(21) Appl. No.: 15/093,225

(22) Filed: Apr. 7, 2016

(30) Foreign Application Priority Data
Apr. 9, 2015 (DE) 10 2015 105 396.9

(51) Int. Cl. G06N 5/04; G06N 99/00

(52) U.S. Cl. CPC G06N 5/048; G06N 99/005

(57) ABSTRACT

An electronic system, e.g. a power supply, includes elements, and the elements include devices that limit reliability of the electronic system. A system that can monitor parameters that affect electronic system reliability such as temperature, and parameters that can predict power supply failure such as bulk capacitor ESR, includes a monitoring system measuring and monitoring at least one reliability limiting parameter of at least one of the devices connected to the monitoring system. A method for estimating and predicting a failure of the electronic system includes: measuring parameters affecting or associating the reliability of the device by sensors, collecting the measured sensor data and/or other data by a communications unit, and communicating the data to a computing device for processing and predicting a failure of the device and alerting to the failure.

### CROSS REFERENCE TO RELATED APPLICATIONS

This application claims priority of German Application No. 10 2015 105 396.9 filed on Apr. 9, 2015, the entire contents of which is hereby incorporated by reference herein.

### FIELD OF THE INVENTION

The present disclosure relates to an electronic system comprising elements and the elements comprising devices that limit the reliability of the electronic system.

The present disclosure also relates to a method for estimating and predicting a failure of that electronic system.

### BACKGROUND OF THE INVENTION

Many electronic systems are expected to operate continuously and tolerate the failure of subsystems and devices. For example, the device failure rate in large scale computer systems means that some type of fault is expected every few hours but nevertheless, the system must remain operational. Several factors contribute to the reliability of the systems, including preventative maintenance and redundancy.

In power supplies the most common point of failure is the bulk capacitors, which have lifetimes of the order of several thousands of hours, and have been the cause of many high profile end product recalls because of reliability issues. However, despite the problems caused by unreliable power supply capacitors, the costs associated with reliable design techniques remains a barrier to their adoption in anything other than high-end systems.

Power supplies typically include a power chain comprising of AC-DC conversion, power factor correction, bus conversion and point of load regulation, as illustrated in FIG. 1.

Typically, system designers ensure reliability by using techniques such as redundancy, derating, the use of more reliable components, thermal management etc. However the costs associated with these techniques mean that power supply reliability is expensive.

Redundancy involves duplicating aspects of the power system so that the additional units may take over the function of the failed device or unit. In addition to the higher cost of providing redundant units, this method also requires a failure to occur before the user is alerted.

Derating involves using components or devices at levels well below their rated specifications, which often involves more expensive and larger components or devices than would otherwise be necessary. As a component's or device's lifetime typically doubles per 10 degrees reduction in operating temperature, derating often involves expensive additional cooling.

Power supply telemetry data is often available by use of the popular PMBUS standard (power management bus standard). Although this has been adopted for monitoring and control, it has a limited role in power supply reliability and does not feature the necessary commands or protocol to communicate with a remote computer system.

In power supplies the most common point of failure are the bulk capacitors. Electrolytic capacitor reliability is significantly affected by the degradation of the liquid electrolyte, especially at elevated temperatures. Tantalum capacitors are an alternative, but they require voltage derating by up to 50% in order to prevent a potential fire hazard. Polymer capacitors are more expensive, but address many of the concerns associated with the reliability of electrolytic and tantalum types. However, a guaranteed lifetime of only 2000 hours is typical and significant degradation at high ripple currents may affect performance and reliability of the power supply.

Therefore what is required is a system that can monitor the parameters that affect power supply reliability such as temperature, and parameters that can predict power supply failure such as bulk capacitor ESR (equivalent series resistance).

### BRIEF SUMMARY OF THE INVENTION

The disclosed invention describes an electronic system where at least one of the devices is connected to a monitoring system measuring and monitoring at least one reliability limiting parameter. An electronic system comprises elements and the elements comprise devices that limit the reliability pf the electronic system, therefore, the functionality of at least that device which limits the reliability of the electronic system most is monitored by a monitoring system.

In the disclosed invention the electronic system can be a power supply comprising elements like an AC-DC converter, a power factor correction, a bus converter and a point of load regulation and the device to be monitored is at least a device of one of these elements.

The monitoring system comprises functional units such as sensors for measuring device parameters, a communications unit communicating with the sensors, a computing unit connected to the communications unit, and a storage means associated with the computing unit. This system can monitor the parameters that affect power supply reliability such as temperature, and parameters that can predict power supply failure such as bulk capacitor ESR. Therefore, different sensors are used to measure relevant parameters. Those parameters are reported to a communications unit that is connected with a computing unit whereas the computing unit may be integrated into a computer system. The communications unit may optionally pre-process the parameters to convert them to a more suitable form or may perform other suitable processing. The computing unit is running a machine learning program in order to predict the failure and lifetime of devices of the power supply. Such a system would have advantages in preventative maintenance by alerting the maintainer to an impending failure. The identification of a faulty product batch that is more prone to failure is another possible advantage. By running machine learning algorithms the system could update its failure probabilities and models based on the measured data and in turn, update the power supplies with the learned reliability data and parameters.

Optionally, the communications unit is connected to a local embedded host by a local communications bus, whereas the embedded host is located within a facility where the monitoring system is located. Therefore, the communicating status includes reliability and the status is communicated for example to microcontroller which may configure the power supply.

Furthermore, the computing unit and its associated storage means are located within a facility where the device to be measured is located meaning locally to the power supply, because the device is part of an element of the electronic system, namely the power supply. Or in another embodiment the computing unit and its associated storage means are located outside a facility where the device to be measured is located namely in a different facility such as a remote data-center. It is therefore particularly advantageous to use the computing unit in a cloud computing based embodiment. It is also advantageous that the monitoring system is connected over cloud computing means with other power supplies and the sensors of these other power supplies building up a database of parameters. Such a cloud based embodiment would allow the Machine Learning system to communicate with many power supplies with the benefit of learning from multiple sensors and power supplies. Additionally, such an embodiment has redundancy benefits against data-center failure or data loss.

The computing unit is an ASIC or a FPGA in order to adapt the performance of the monitoring system individually to the present circumstances. Signals are output from the ASIC or FPGA to alert the user to an impending failure or provide an indication of time to failure or the like.

The computing unit may be configured to communicate the imminent failure to the power supply to alert the user. The optional local microcontroller may perform the Alert function. In order to signalize that the computing unit has calculated or would predict an impending failure and a limited lifetime of the power supply, the computing unit is connected to indicator function means such as a light emitting diode or a status register.

Advantageously, the monitoring system is incorporated into a digital power control IC or a power management integrated circuit (PMIC) comprising all of the power controllers, sensors, estimators, observers and communications and processing logic. The result is a very compact construction and design type.

Where IC technology allows, the monitoring system may be integrated on a chip. A System on Chip (SoC) may be feasible in which the sensor, processing and learning algorithms are incorporated into an integrated circuit. Suitably, the power controller, drivers and switches of a switch mode power converter may be integrated.

The disclosed invention describes also a method for estimating and predicting a reliability limiting failure of an electronic system comprising following steps: measuring parameters affecting or associating the reliability of the device by sensors, collecting the measured sensor data and/or other data by a communications unit, communicating the data to a computing unit for processing and predicting a failure of the device and alerting to the failure. Appropriate sensors measure parameters known to affect, or may be associated with the reliability of the power supply. Such parameters may include output voltage, average current, temperature, ESR (equivalent series resistance) and capacitance of the bulk capacitors. System identification or estimation may be employed to infer unmeasured parameters or signals. These measured sensor data and/or other data is collected by a communications unit that can pre-process the parameters to convert them to a more suitable form or may perform other suitable processing or it communicates the data directly to the computing unit for processing and predicting a failure of the device and altering the failure.

Advantageously, the computing device runs a machine learning program for estimating, learning and predicting the failure of the device. The device can be a bulk capacitor of a power supply, but also a device of a power converter where reliability can be usefully monitored and predicted including elements such as AC-DC converters, Power Factor Correction, DC-DC converters, isolated and non-isolated converter types. In addition, the invention may also predict things other than failure and reliability. Similar techniques utilizing similar data may be used to predict when power saving modes should be switched on by monitoring power efficiency and computational demand on the system.

The machine learning program processes the collected and communicated sensor data and/or other data. Therefore, it uses algorithms such as Anomaly Detection, Neural Network, K-Nearest Neighbour, Linear Regression, Markov Chain Monte Carlo, Hidden Markov Modelling, Naive Bayes or Decision Trees. It will be clear to a person having ordinary skill in the art that other Machine learning algorithms may also be beneficial.

The computing unit may provide useful statistics and detailed performance data regarding the operation and reliability of the monitored power supplies to a user. In a cloud based embodiment this may be achieved via a suitably designed web interface. The advantage of using the monitoring system with the machine learning program is that the system could aggregate the data from many remote power supplies, building up a database of parameters and learning the failure probabilities according to the data. Such a system could utilize cloud computing features to collect sufficient data from many power supplies, over many vendors.

### BRIEF DESCRIPTION OF THE DRAWINGS

Reference will be made to the accompanying drawings, wherein:

FIG. 1 shows a typical electronic power system (state of the art)

FIG. 2 shows an overview of the inventive system;

FIG. 3 shows a supervised classification algorithm;

FIG. 4 shows a classification example using the invention.

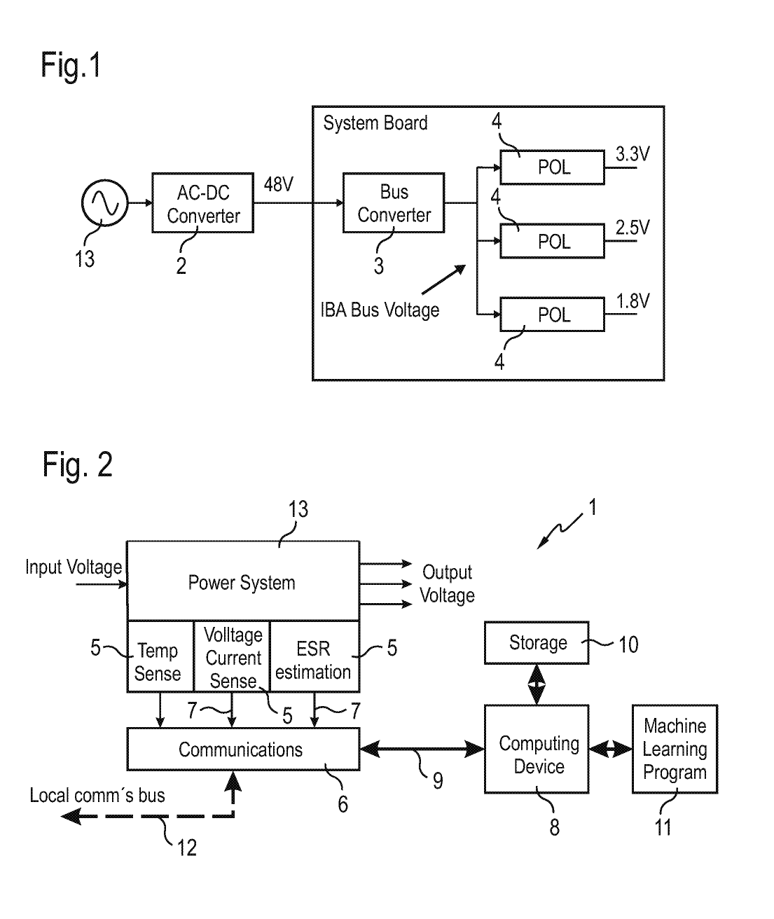

### DETAILED DESCRIPTION OG THE INVENTION

In order to illustrate the advantages of the invention consider a power supply 13 whose parameters are measured by sensors 5 as shown in FIG. 2. Appropriate sensors 5 measure parameters known to affect, or may be associated with the reliability of the power supply 13. Such parameters may include output voltage, average current, temperature, ESR (equivalent series resistance) and capacitance of the bulk capacitors. System identification or estimation may be employed to infer unmeasured parameters or signals.

The communications unit 6 communicates 9 the parameters to the computing unit 8 and may optionally pre-process the parameters to convert them to a more suitable form or may perform other suitable processing. Optionally, a local communications bus 12 may be associated with the communications block 6, communicating status including reliability to a local embedded host such as a microcontroller which may also configure the power supply 13.

The computing unit 8 and its associated storage 10 and program code 11 may be located within a facility where the device to be measured is located, for example locally to the power supply 13 or outside a facility where the device to be measured is located namely in a different facility. For example in a cloud computing based embodiment the computing unit 8 would be suitably located in a remote data-center. Such a cloud based embodiment would allow the monitoring and machine learning system to communicate with many power supplies with the benefit of learning from multiple sensors and power supplies. Additionally, such an embodiment has redundancy benefits against data-center failure or data loss.

The computing unit 8 may run a machine learning program 11, the purpose of which is to estimate and predict the failure of the power supply 13 by processing the communicated sensor data 7 and/or other data that may be available such as user inputted data. The computing unit 8 may be configured to communicate the imminent failure to the power supply 13 to alert the user. The optional local microcontroller may perform the Alert function.

The computing unit 8 may provide useful statistics and detailed performance data regarding the operation and reliability of the monitored power supplies 13 to a user. In a cloud based embodiment this may be achieved via a suitably designed web interface.

In another embodiment the machine learning algorithm 11 may execute on an ASIC or an FPGA whereby signals are output from the ASIC or FPGA to alert the user to an impending failure or provide an indication of time to failure or the like.

The monitoring and machine learning system 1 may execute algorithms 11 such as Anomaly Detection, Neural Network or K-Nearest Neighbour to predict the probability of power supply failure based upon the data received. It will be clear to a person having ordinary skill in the art that other Machine learning algorithms such as Linear Regression, Markov Chain

Monte Carlo, Hidden Markov Modelling, Naive Bayes, Decision Trees and the like, may also be beneficial.

Considering an embodiment in which a Bayesian Inference algorithm receives data from the power supply (or supplies). Given the data D and various models M1, M2 incorporating parameters and representing various scenarios such as 1) a power supply close to failure and 2) a power supply 13 far from failure, the impending failure of the power supply 13 can be determined by executing an algorithm 11 according to Baye's rule in order to select the most appropriate model for the data (close to failure or far away from failure):

$$p ( {M}_{i} \vert D ) = \frac{p ( D \vert {M}_{i} ) \cdot p ( {M}_{i} )}{p ( D )}$$

where i selects the model, p(Mi\D) is the posterior indicating the probability that the data applies to Model i, p(D\Mi) is the likelihood of the data given the model and is the prior probability. This algorithm may be continuously updated to learn from new data with the prior being seeded by the posterior on each iteration. Competing models may be evaluated according to the ratio of their posteriors to determine which scenario is more likely. It will be clear that several additional parameters and models are easily accommodated by the algorithm by means of the calculation of joint probabilities in order to establish the probability of failure.

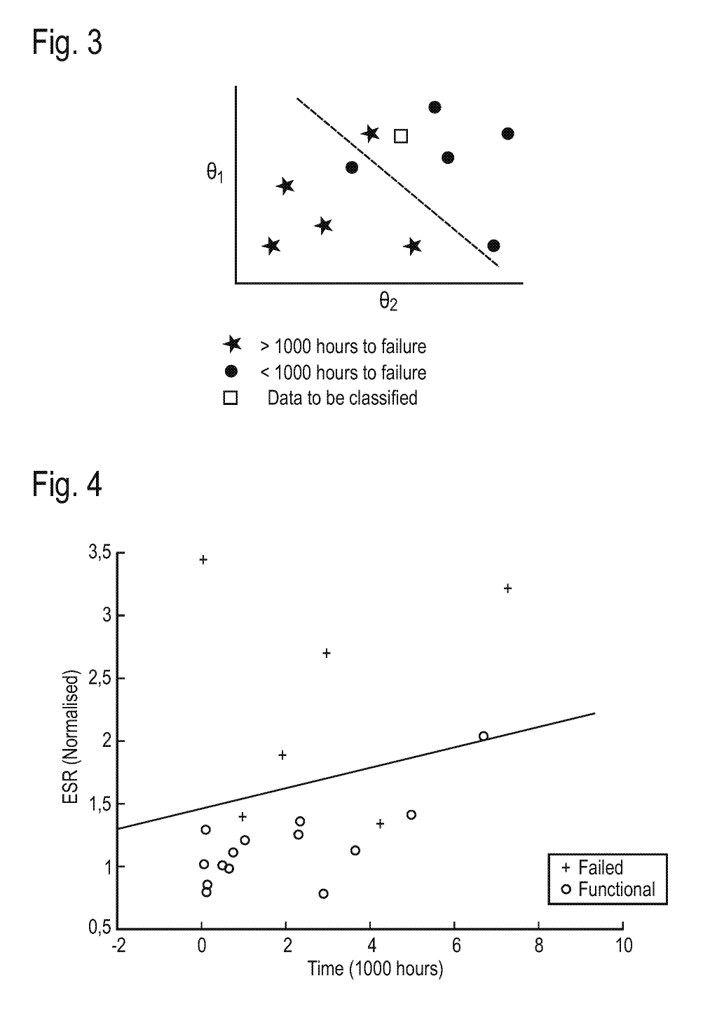

Considering an embodiment in which a supervised classification type of algorithm such as K-Nearest Neighbour (KNN) is employed. FIG. 3 depicts the parameter space (simplified to two parameters for clarity), consisting of parameters such as temperature, ESR, hours of operation and the like, denoted as θ1 and θ2. Training data is denoted by stars for devices that are known to be greater than 1000 hours from failure and circles for devices known to be less than 1000 hours from failure. During training, the requirement of the machine learning algorithm such as KNN is to optimally divide the parameter space, into regions according to the most likely classification in the presence of noise and uncertainty in observations and underlying variables, as denoted by the dashed line. Once trained, the KNN algorithm is required to classify data of unknown classification that is presented to it, as denoted by the square symbol. The KNN can learn continuously as the correct classification of the data becomes known by observation over time.

Having learned the reliability of the power supply 13, the monitoring system 1 may take action based upon that learning. For example, an indicator function such as an LED or a status register may alert a user or supervising system to take suitable action. In a data center a supervising unit could move processing tasks away from a server that is predicted to suffer an imminent failure. In another example, an organization may be alerted to a batch of product with abnormally early failures and may issue a product recall. In another example, having been alerted to imminent failures, a supplier may re-configure the affected product to avoid the imminent failure or to minimize the damage caused.

It may be advantageous to incorporate the teachings of this invention into a digital power control IC or a Power Management Integrated Circuit (PMIC) whereby integration of some or all of the power controllers, sensors, estimators, observers and communications and processing logic is economical. Such a device would usefully incorporate a local communications bus for the purposes of configuration and monitoring of the power controller including reliability status. Where integration with a power controller may not be economical or compatible an IC or Sub-System according to the teachings of this invention can be envisaged.

Where IC technology allows, a System on Chip (SoC) may be feasible in which the sensor, processing and learning algorithms are incorporated into an integrated circuit. Suitably, the power controller, drivers and switches of a switch mode power converter may be integrated.

It can be envisaged that the teachings of this invention are not limited and are suitable for all power converters where reliability can be usefully monitored and predicted including AC-DC converters, Power Factor Correction, DC-DC converters, isolated and non-isolated converter types.

End equipment such as servers, data centers, network switches and infrastructure may all benefit from the teachings of this invention.

This invention also suggests a method of learning and estimating device and system reliability according to the disclosed teachings.

In addition, the invention may predict things other than failure and reliability. Similar techniques utilizing similar data may be used to predict when power saving modes should be switched on by monitoring power efficiency and computational demand on the system.

1. An electronic system comprising elements and the elements comprising devices that limit reliability of the electronic system, wherein at least one of the devices is connected to a monitoring system measuring and monitoring at least one reliability limiting parameter.

2. The electronic system according to claim 1, wherein the electronic system comprises a power supply, the elements comprise an AC-DC converter, a power factor correction, a bus converter, and a point of load regulation, and one of said elements is connected to the monitoring system measuring and monitoring at least one reliability limiting parameter.

3. The electronic system according to claim 1, wherein the monitoring system comprises sensors for measuring device parameters, a communications unit communicating with the sensors, a computing unit connected to the communications unit, and a storage means associated with the computing unit.

4. The electronic system according to claim 3, wherein the communications unit is connected to a local embedded host by a local communications bus, and the embedded host is located within a facility where the monitoring system is located.

5. The electronic system according to claim 3, wherein the computing unit and the storage means are located within a facility where the at least one of the devices connected to the monitoring system is located.

6. The electronic system according to claim 3, wherein the computing unit and the storage means are located outside a facility where the at least one of the devices connected to the monitoring system is located.

7. The electronic system according to claim 6, wherein the computing unit and the storage means are located in a different facility than where the at least one of the devices connected to the monitoring system is located.

8. The electronic system according to claim 8, wherein the computing unit and the storage means are located at a remote data-center.

9. The electronic system according to claim 2, wherein the monitoring system is connected over cloud computing means with other power supplies and sensors of the other power supplies building up a database of parameters.

10. The electronic system according to claim 3, wherein the computing unit comprises an ASIC or a FPGA.

11. The electronic system according to claim 3, wherein the computing unit is connected to indicator function means.

12. The electronic system according to claim 11 wherein the indicator function means comprises at least one of a light emitting diode or a status register.

13. The electronic system according to claim 1, wherein the monitoring system is incorporated into a digital power control IC or a power management integrated circuit (PMIC) comprising all power controllers, sensors, estimators, observers and communications and processing logic.

14. A method for estimating and predicting a reliability limiting failure of an electronic system comprising the following steps: measuring parameters affecting or associating reliability of a device by sensors, collecting measured sensor data and/or other data by a communications unit, communicating the data to a computing unit for processing, and predicting a failure of the device and alerting to the failure.

15. The method for estimating and predicting a reliability limiting failure of an electronic system according to claim 11, wherein the computing unit runs a machine learning program for estimating, learning and predicting the failure of the device.

16. The method for estimating and predicting a reliability limiting failure of an electronic system according to claim 12, wherein the machine learning program processes the collected and communicated sensor data and/or other data.

17. The method for estimating and predicting a reliability limiting failure of an electronic system according to claim 11, wherein the machine learning program uses at least one of the following algorithms: Anomaly Detection, Neural Network, K-Nearest Neighbor, Linear Regression, Markov Chain Monte Carlo, Hidden Markov Modelling, Naive Bayes or Decision Trees.

18. The method for estimating and predicting a reliability limiting failure of an electronic system according to claim 11, wherein the computing unit is used in a cloud based environment, and is configured via a web interface.
